(19) United States
(12) Patent Application Publication
(10) Pub. No.: US 2003/0208382 A1
(43) Pub. Date: Nov. 6, 2003

(54) Electronic medical record system and method

(76) Inventor: Mark D Westfall, Neenah, WI (US)

Correspondence Address: Michael J Gratz, Boyle Fredrickson Newholm Stein & Gratz, Suite 1030, 250 East Wisconsin Avenue, Milwaukee, WI, 53202, US

(21) Appl. No.: 10/240,613

(22) PCT Filed: Jul. 5, 2001
(86) PCT No.: PCT/US01/21192

(51) Int. Cl. G06F 17/60

(52) U.S. Cl. 705/3

(57) ABSTRACT

A system for storing medical records (15) which is comprised of a global communications network (12), a personal computer or terminal (14) linked to the global communications network (12) including a first connection port and a portable data access device connected to the first connection port is disclosed. The portable storage device preferably contains a processor, a memory, and an input device. An electronic patient record (15) is also disclosed. The patient record is carried by the portable data access device and may be updateable via the global communications network (12), the personal computer (14), or the input device acting in communication with the storage device. The patient record (15) contains personal patient information, such as disease/treatment history, and health insurance/medication information. The storage device may also generate patient reminders instructing a patient to schedule appointments. The input device is used to log into the portable device or terminal (14).

### CROSS-REFERENCE TO RELATED APPLICATION

This application claims priority under 35 U.S.C. §119(e) to U.S. Provisional Patent Application No. 60/215,980, filed Jul. 5, 2000, the entirety of which is incorporated by reference herein.

### BACKGROUND OF THE INVENTION

1. Field of Invention

The present invention relates generally to the field of electronic record keeping. More particularly, the present invention relates to medical record keeping with the use of a remote DATA ACCESS DEVICE and a global communications system.

2. Discussion of Related Art

The use of a remote, data access device (preferably a PORTABLE DATA ACCESS DEVICE, e.g., a handheld computer, a personal digital assistant, palm top device, etc.) for the keeping of information such as telephone numbers, appointments, and other data specific to the owner or user of the PORTABLE DATA ACCESS DEVICE is well known. Similar devices are known to be used by physicians to access patient data, such as a phone number. However, neither of these devices allows an individual or consumer 24-hour mobile access to his or her own medical records electronically. The present invention seeks to solve this problem.

### SUMMARY AND OBJECTS OF THE INVENTION

The present invention is directed to personal medical record keeping by the individual owner of a remote, DATA ACCESS DEVICE. A primary object of the invention is to allow an individual 24-hour mobile access to his or her own medical records. Another object is to allow an individual to update his or her own medical records and to keep them current. A third object of the invention is to allow health care providers 24-hour mobile access to the individual's medical records and the ability to update those records. Still another object of the invention is to provide individuals a link to a global communications network to help them continuously update and access their personal medical records and synchronize the same for archival backup purposes.

In accordance with a first aspect of the invention, these objects are achieved by providing an apparatus comprising a portable data access device, such as a handheld computer, a personal digital assistant or a palm top, which is able to store and display information on its owner's medical condition and medical history. In accordance with a second aspect of the invention, these objects are achieved by providing a link between the remote, DATA ACCESS DEVICE and a personal computer (PC), and/or providing a link between either of those devices and a global communications network.

These and other aspects and objects of the present invention will be better appreciated and understood when considered in conjunction with the following description and the accompanying drawing. It should be understood, however, that the following description, while indicating preferred embodiments of the present invention, is given by way of illustration and not of limitation. Many changes and modifications may thus be made without departing from the scope of the present invention, and this invention includes all such modifications.

### BRIEF DESCRIPTION OF THE DRAWING

FIG. 1 schematically illustrates one embodiment of a system of present invention;

FIG. 2a schematically illustrates a preferred embodiment of computer in which the system of present invention is intended to be used;

FIG. 2b schematically illustrates one embodiment of a system of present invention;

FIG. 3 schematically illustrates one embodiment of the system of the present invention's user hierarchy;

FIG. 4 shows one embodiment of the relationships of the data of the present invention;

FIG. 5 is a continuation of FIG. 4 showing one embodiment of the relationships of the data of the present invention;

FIG. 6 is an alternative embodiment of the relationships of the data of the present invention;

FIG. 7 shows a patient card of one embodiment of the present invention;

FIG. 8 shows the security module of one embodiment of the present invention;

FIG. 9 shows a web module of one embodiment of the present invention;

FIG. 10 shows product module of one embodiment of the present invention;

FIG. 11 shows a patient/member portal of one embodiment of the present invention;

FIG. 12 shows file relationship tables of one embodiment of the present invention;

FIG. 13 shows a continuation of file relationship tables of FIG. 12;

FIG. 14 shows a record release system shows file relationship tables of one embodiment of the present invention;

FIGS. 15-31 illustrate screen portions with preferred data fields used to create a medical record of the system of the present invention;

FIG. 32 shows an example of a preferred report generated by the system of the present invention.

### DESCRIPTION OF PREFERRED EMBODIMENTS

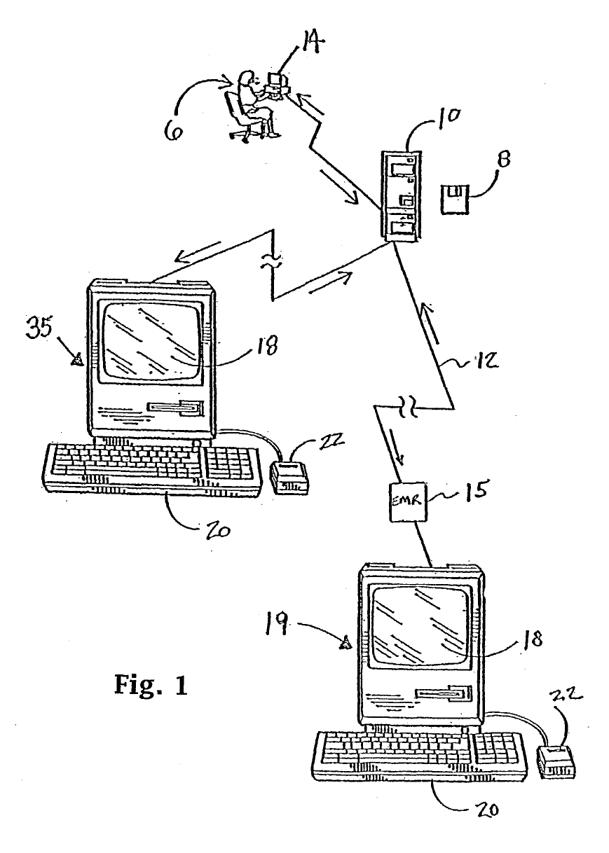

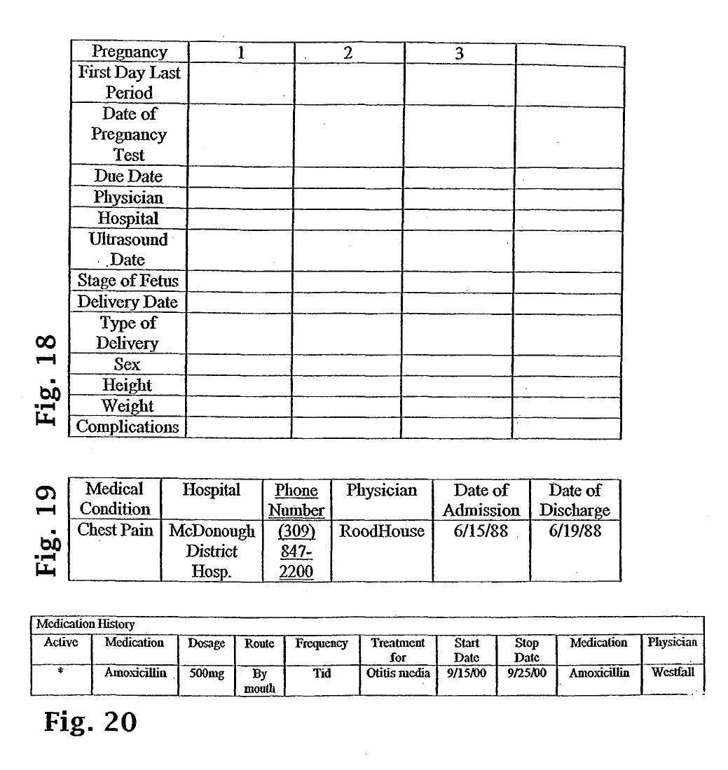

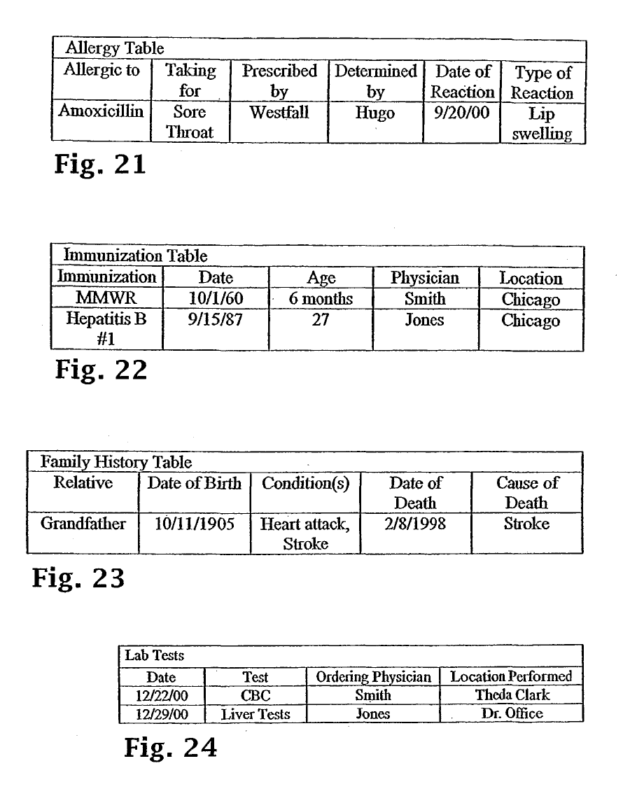

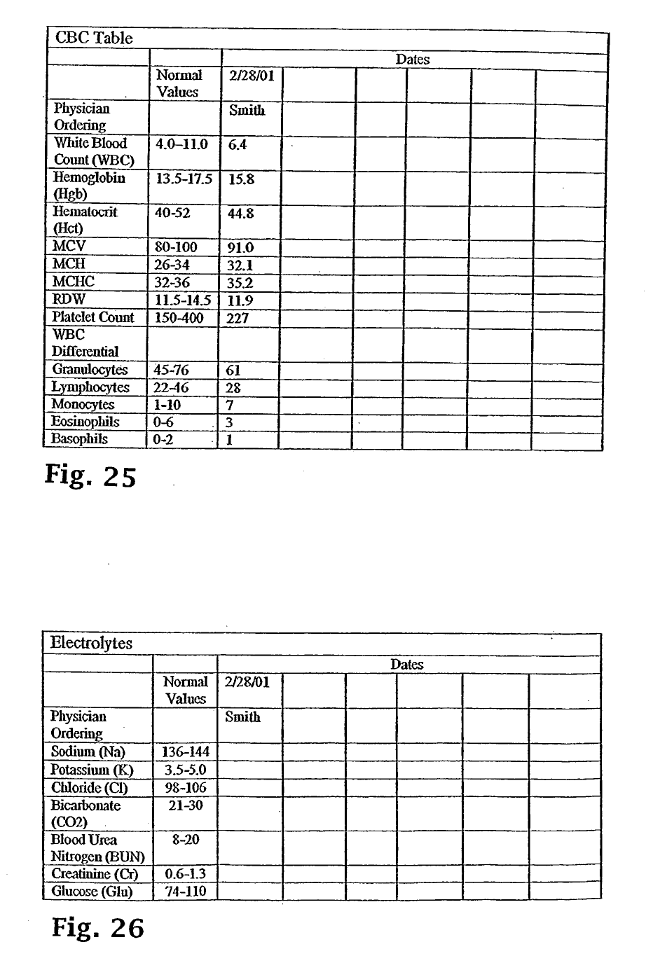

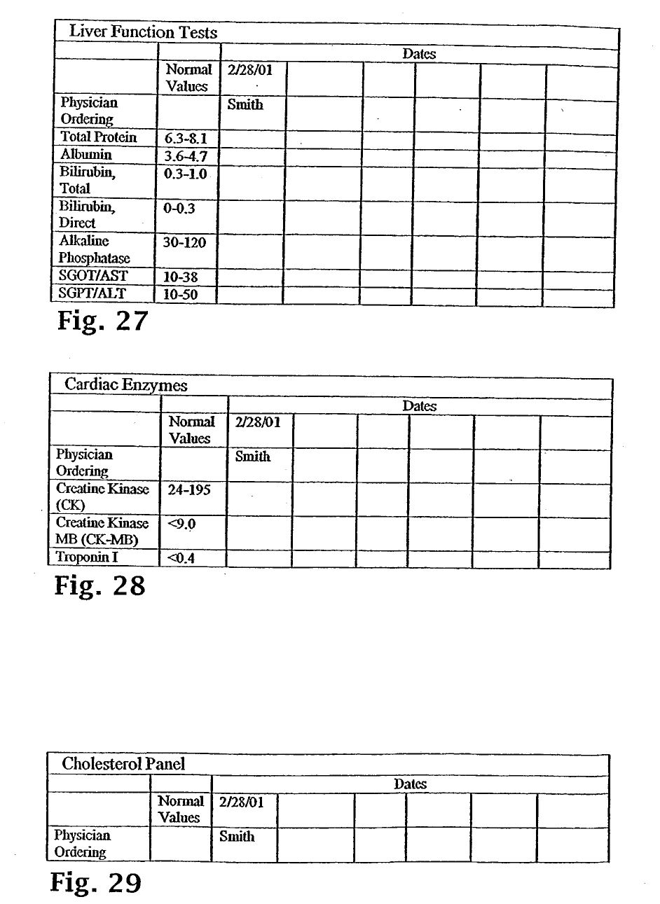

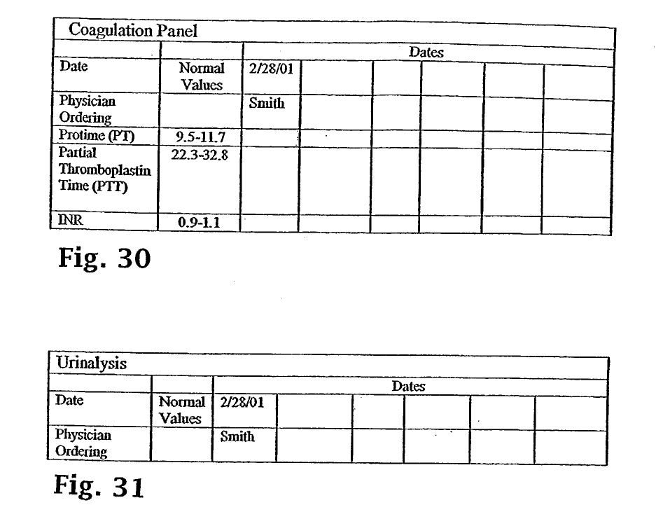

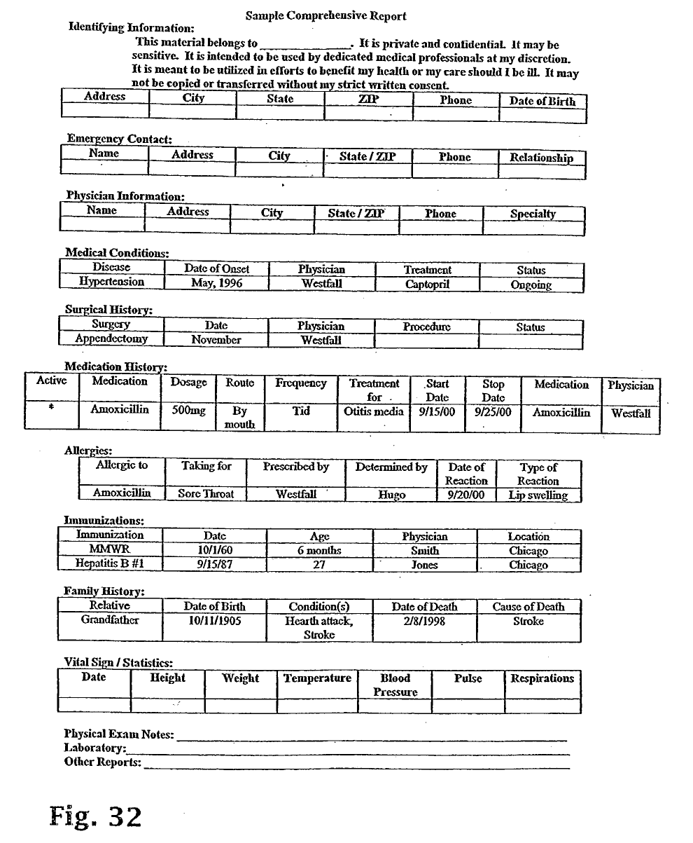

Referring now to the drawings, flow charts and screens shown in FIGS. 1-32, it can be seen that the present invention is preferably a computer-based electronic patient medical record management system. Preferably implemented in a computer program or software 8 (which may include a plurality of subprograms or modules), this inventive electronic system 5 allows providers or their designated representatives (i.e., users) 6 to interactively input a patient's medication and therapy data into a central host computer 10, for example a server, over a computer network or communications network 12. The system 5 automatically records the data in a file, creates a database, updates any previously recorded data with the current status information, closes the data file from further updates when appropriate, and notifies the physician when the updating is complete.

As best shown on FIG. 1, the system 5 of the present invention is preferably accessible by many users 6 through remote terminals or workstations 14. A preferred network 12 for implementing the present invention is a wide area network entered through the Internet which is accessible by a significant percentage of the U.S. population. The network 12 may also be a local area or limited area accessible network. Other alternative communications networks may include telephone or cable land lines connected via modems, analog or digital cell phone networks, satellite communications networks, etc. One skilled in the art would realize a wide variety of communications means exists to link to user 6 and the user's terminal 14 with server computer 10

In FIG. 1, the user 6 is a patient or a system 5 member who has proper authorization to access the system. The author or provider terminal 19 is preferably located in a physician's or some health care provider's office. The physician creates or authors medical data when the patient member 6 is examined or treated by the provider. The provider or one of the provider's staffers may then access the system 5 through a password to enter and transmit the medical data to the system's server 10 via the lines 12. Once entered into the system, the data creates an electronic medical record 15.

The data 15 is then transmitted from the server 10 to the terminal 14 of the user 6 electronically. The record and the data is then reviewed by the member user 6. After review, the member can then either accept the data in its entirety or reject it. If the data is rejected, the system then works with the provider and the member to reconcile the reason for the rejection of the data. After the problem has been resolved the data is stored within the system and becomes part of the permanent medical record of the member user 6. The medical record 15 can then be accessed by a third party terminal 35 in read only format if the member 6 is in a medical emergency situation. For example, after an accident an emergency room member may access the system 5 to determine if the user patient 6 is allergic to certain pain killers.

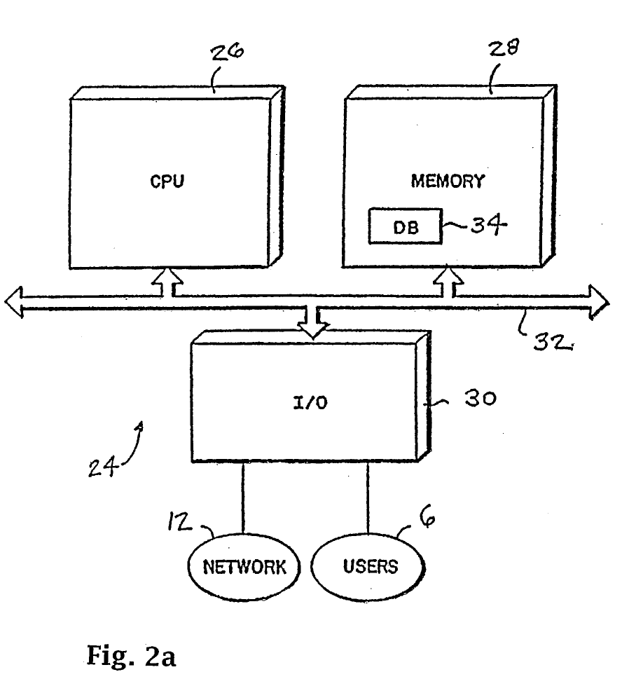

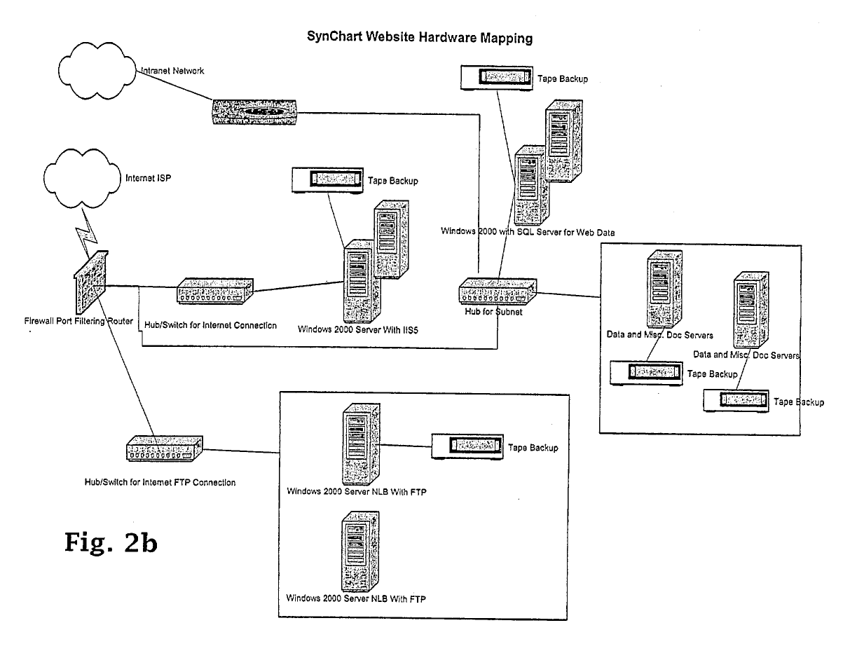

Referring to FIG. 2, database 34 is preferably used for maintaining provider and patient information and other relevant information. The database 34 may be developed from nearly any commercially available database system. Searches are preferably performed periodically to update and load relevant information into the database 34. Once the database 34 is loaded with information from the item or field and the item is scheduled to be updated, the system 5 copies the relevant information from the database into a human readable page for viewing.

The central server host computer 10 preferably is a computer system 24 as shown in FIG. 2a. The computer system 24 includes a central processing unit (CPU) 26, a memory 28, and an input/output (“I/O”) interface 30 connected to each other by a communications bus 32. The CPU 26 executes all software programs 8 of the system 5 necessary for manipulating data. The programs 8, medical records 15, and other data records 23 (such as provider or emergency room information) can be stored in the memory 28 as a database (DB) 34.

The memory 28 may include volatile semiconductor memory as well as persistent storage media, such as drives, disks, tapes, or discs.

The I/O interface 30 is for communicating data with the network 12, the user 6, and other computer system peripheral equipment, such as printers, tape drives, hubs, routers, etc. The interface 30 (e.g., screen 18, keyboard 20, mouse 22 shown in FIG. 1) preferably allows the system user to input data or communicate on-line via the Internet. The computer system 24 is scaled in size to function appropriately.

The configurations of the computer system 24 suitable for use by the system may include multiple processors and large database equipped with “fail-safe” features including redundancy, surge controls, and security firewalls. The fail-safe features ensure that the database 34 is securely maintained for long periods of time.

One preferred configuration for the system 5 is shown in FIG. 2b. The main portion of the system consists of preferably SQL servers for Web data loaded with Windows 2000 software. Each SQL server preferably has a tape backup. Preferably also there is router with an intranet connection. A hub then connects the Web server(s) to data and miscellaneous document servers with tape backups. There are also preferably additional servers and tape backups with a hub switch which allows for connection to the firewall portal filtering router. After the firewall, an additional hub switch allows for Internet transfer protocol connection. Additional NLB servers and tape backups may also be part of the system which allows for external global network Internet service provider (ISP) connection.

The remote, data access device or terminal of the system 5 may be any device that can send and/or accept e-mail or other messages. Such devices include: a personal computer, desktop, notebook, mainframe computer, cellular phone, laptop, PDA, PCS phone, WEB TV terminal, Motorola Iridium phone/terminal, pager, Ultra Wide Band Technology, Globalstar Systems and Loral Systems.

One preferred embodiment of the invention herein described requires the use by a member user 6 of a remote data access device 14 like a portable personal digital assistant such as those currently commercially available. Such a PORTABLE DATA ACCESS DEVICE preferably operates using Palm® OS and Windows® CE. The PORTABLE DATA ACCESS DEVICE also should be able to connect directly to a PC or a global communications network through the use of a connection port (sometimes referred to as a “hot sync”). The PC preferably operates in Windows® 98/NT/00, has the ability to directly connect with the PORTABLE DATA ACCESS DEVICE, and has a modern or similar capability for connection with a global communications network. The PORTABLE DATA ACCESS DEVICE may also have a wireless modem for connecting with a global communications network.

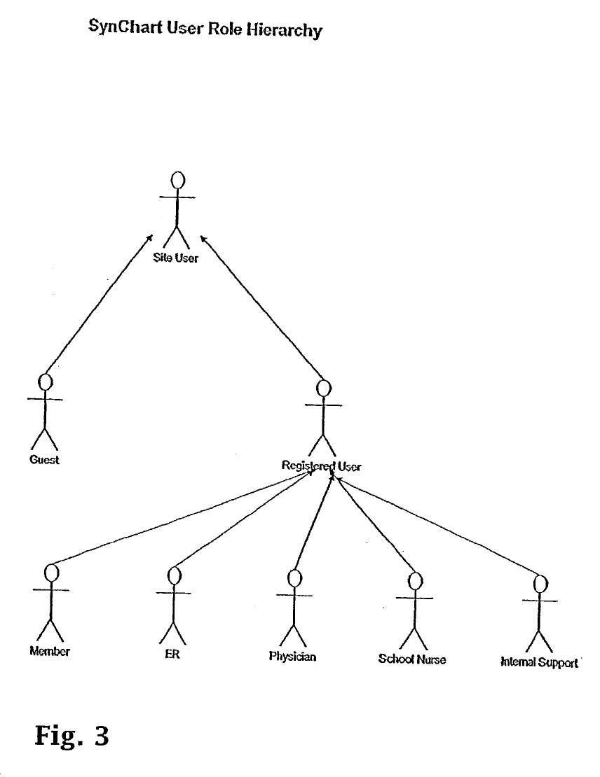

Referring now to FIG. 3, any information that would normally be filed in a patient's medical records through his or her primary physician, ancillary providers, or hospital is also filed in the memory 28 of the system 5 of the present invention. This gives the individual owner and any user authorized by the owner, such as an emergency room triage nurse, a pharmacist, or any medical care provider unable to access the individual's medical records due to a remote location or an inconvenient hour, the ability to immediately view the individual's medical records and thus provide better service to the patient.

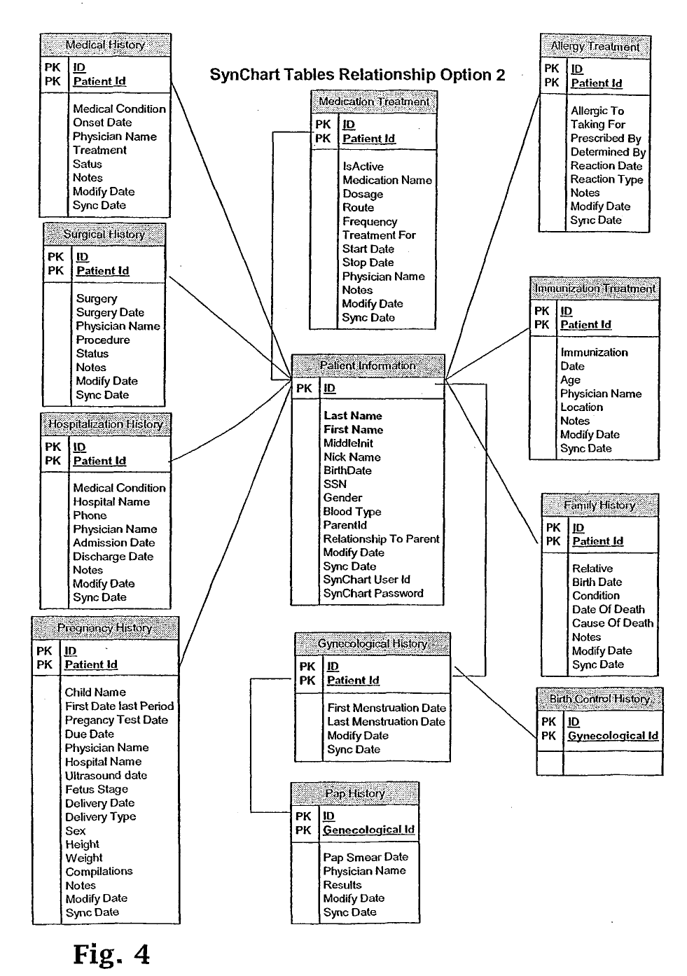

Referring in general now to FIG. 4, the PORTABLE DATA ACCESS DEVICE stores files of data concerning the individual's medical condition and history. Emergency medical information such as existing medical problems or conditions, most recent test results, drug allergies, current prescriptions, emergency contact names and telephone numbers, primary physician name, and family history are thus available for review. Lists of allergies, medications, immunizations, hospitalizations, prior surgeries, prior medical conditions and treatments, and test results are available for reference. Current medical treatments and physical profile information taken from most recent physical exam are also able to be stored and accessed via the PORTABLE DATA ACCESS DEVICE. Items such as blood type, ongoing medical conditions, and routine test results such as blood tests, urinalysis, cholesterol levels, and prescription schedules and dosages are stored in the memory of the PORTABLE DATA ACCESS DEVICE and can be accessed and updated at the discretion of the owner.

It has been noted that the invention can store information on prescription schedules and dosages. In addition to storing that information, the PORTABLE DATA ACCESS DEVICE is also able to serve as task reminder. The PORTABLE DATA ACCESS DEVICE signals its owner when it is time to perform a particular task, such as taking medication, or when the next doctor's appointment is. For example, the reminder may indicate which medicine to take and how much to take, and may supply the owner with instructions about the drug and its interactions, such as “take with food,” “take with meals”, “take between meals”, “take with milk”, “take before sleeping”, “do not operate heavy machinery”, “may make drowsy”, “can cause dizziness,” etc. This feature can allow for better health care compliance and thus better health.

FIG. 3 best shows some possible user hierarchies of the system 5. For example, the system 5 user may be a website user who has access to the system website. That person may be a guest who is visiting aside for further information and e-commerce. Alternatively, the site user may be a registered user such as a member user 6 or any of several third party users such as ER technicians, physicians, school administrators, school nurses, internal support personnel, nursing home personnel, day-care personnel, family members, etc.. Further, the registered user may also be a primary care physician of a member user 6 who may have limited access to the system to allow for medical document review and updating.

FIG. 4 and FIG. 5 show some possible data that may be included in any of several files located in a typical medical record. They include medical history, surgical history, hospitalization history, pregnancy history, medication treatment, general patient information, gynecological history, allergy treatment history, immunization treatment history, family history, birth control history, vital signs statistic information, and physical exam notes. As shown in FIG. 4 and 5, each of these files contain numerous data fields which can be populated with a wealth of member patient information. FIG. 4 and 5 also illustrate how the data fields and files are interconnected for ease-of-use and access by the user.

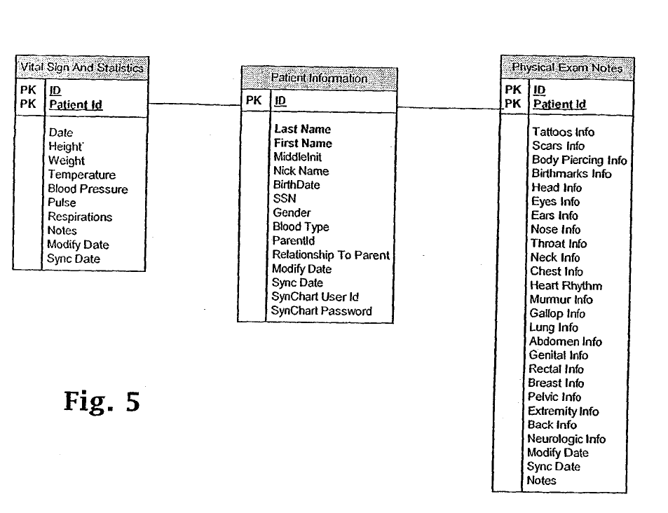

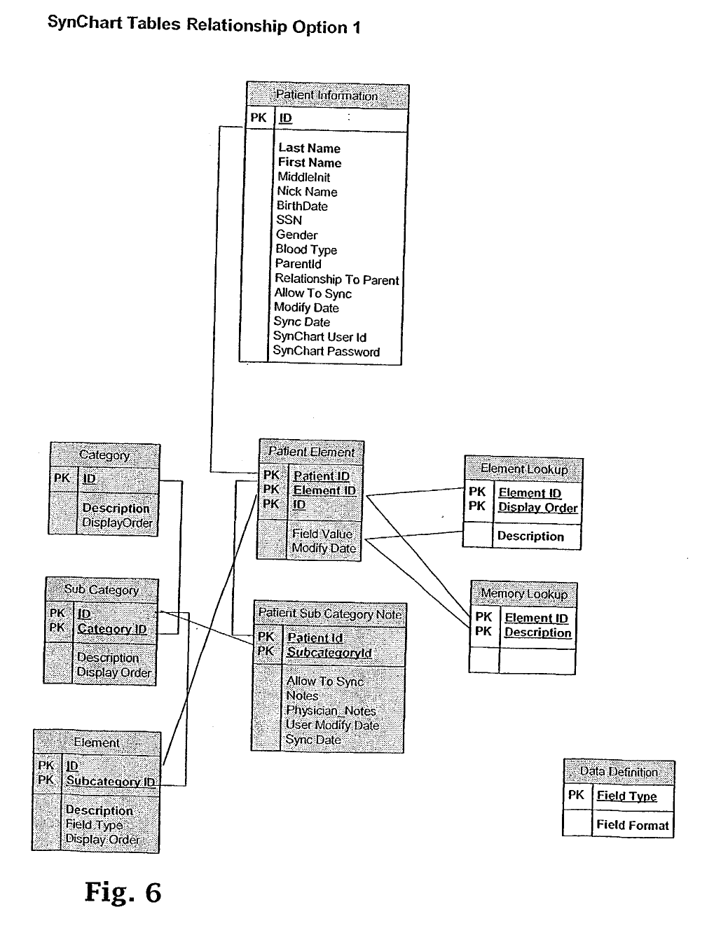

FIG. 6 shows similar medical record data files and the information arranged an alternative manner for use and cross-reference.

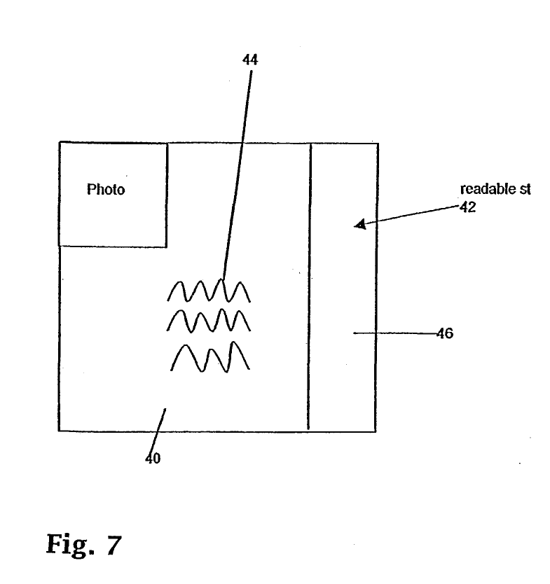

FIG. 7 shows an illustration of one embodiment of the system access module or security module 50. In one embodiment, the member user 6 is issued an identification or subscriber card 40. The card 40 contains a readable media 42, such as a magnetic strip or barcode, basic member information such as name, birth date, etc. 44, system access information 46, and a photograph 48. In one embodiment, the system access information and basic member information including a member number may be contained on the readable media.

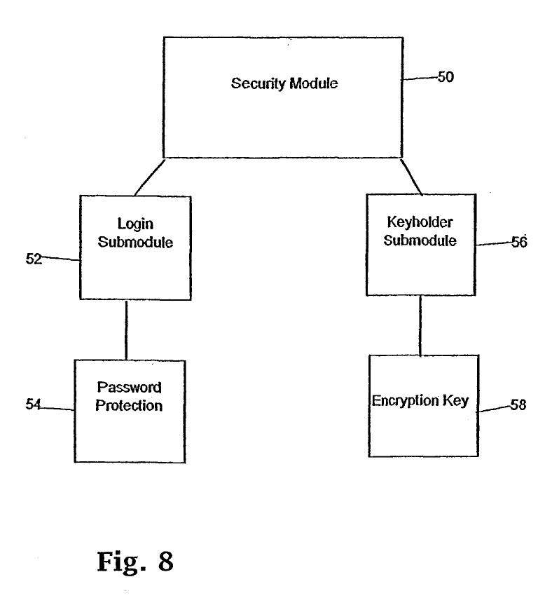

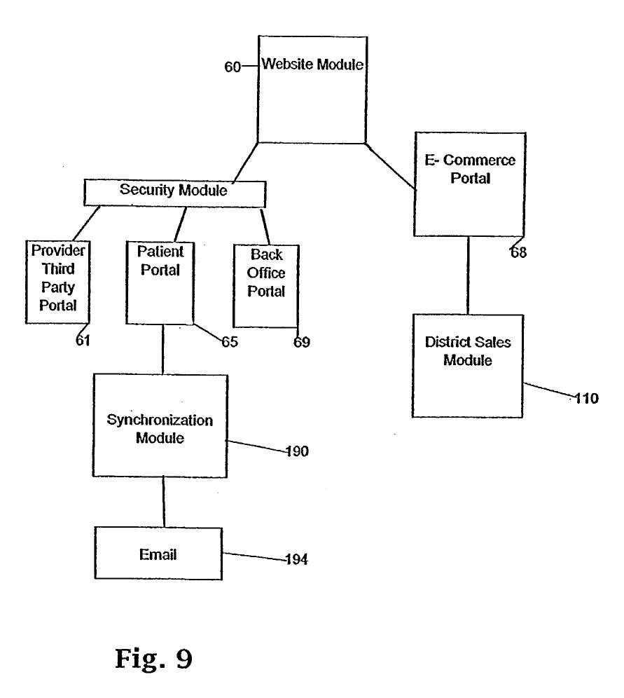

In FIG. 8, the security module 50 is shown having two submodules. The submodules include in the preferred embodiment a login submodule 52 which allows for access through a web module 60 (as shown in FIG. 9). This submodule 52 allows the user to access a portion of a website which is password 54 protected. The other submodule, is a keyholder submodule 56 which allows access to a desktop application or product protection module 80 through the use of an encryption key 58. Of course, it is possible that access to the Web site module 60 and/or product module 80 may be any combination or subtraction of both such submodules.

FIG. 9 illustrates the various functions of the web module 60. As mentioned previously, access to one portion of the website module is controlled by the security module 50. The security module 50 controls access to provider/third party portal 61, member/patient portal 65, and back office portal 69. The other portion of the website module 60 is open to any visitor to allow access to any e-commerce portal 68. The e-commerce portal 68 offers general medical information, advertising in product marketing information, and a direct sales module 110 which allows one to purchase an offered service and product. The direct sales module 110 may further contain mechanisms for various functions such as verification of credit card information, member registration information, and order placement and fulfillment.

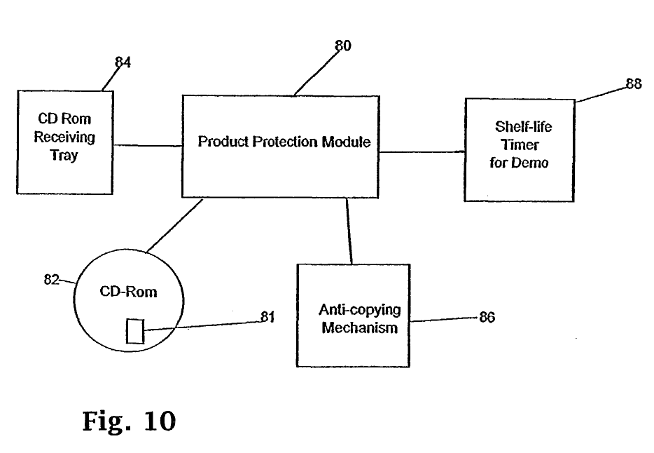

As the shown in FIG. 10, the product module 80 is geared toward the desktop application. In one preferred embodiment, the desktop application consists of a compact disc (CD) read only memory (ROM) device 82 having software 81 contained upon it. Within the CD is an anticopy mechanism 86 which may be hardware physically embedded into the CD or embedded into the software. If this CD is loaded into a CD receiving tray 84, a handshake occurs and the user 6 is able to access the medical records data from the website or the computer memory. If this CD is not in the receiving tray access is denied. If this CD is a demonstration CD, the software contains a shelf life timer 88, which eventually expires and thus locks the user out of the system 5. Therefore, the user is denied access to the medical record(s).

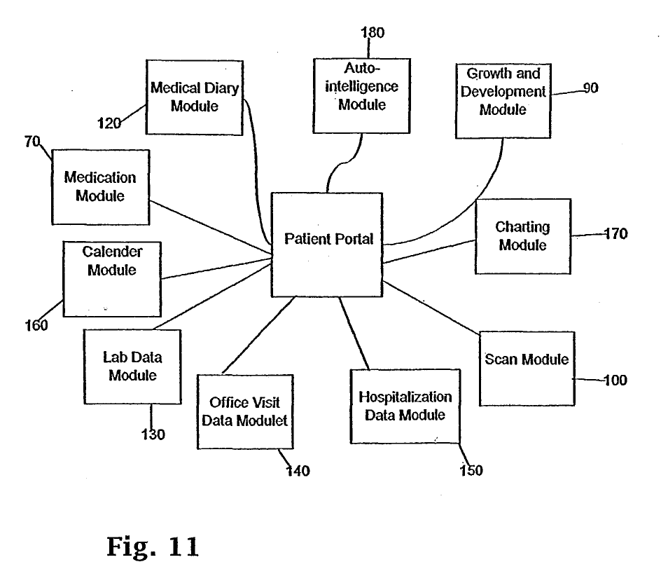

As briefly mentioned, earlier the user members 6 have access to a patient portal 65. As been shown in FIG. 11, the patient portal 65 opens up a wide variety of functionality and allows the member 6 to populate a number of data fields and medical record files with lots of information. In one preferred embodiment, the patient portal 65 also allows access to a medication module 70, a growth and development module 90, a scan module 100, and medical diary module 120, a lab data module 130, and office visit data module 140, hospitalization data module 150, a calendar module 160, and a charting module 170.

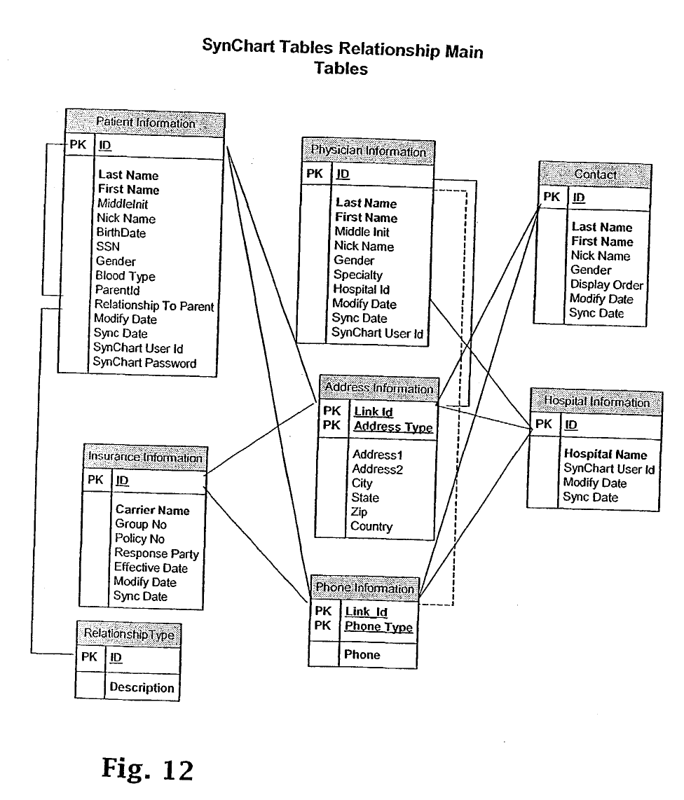

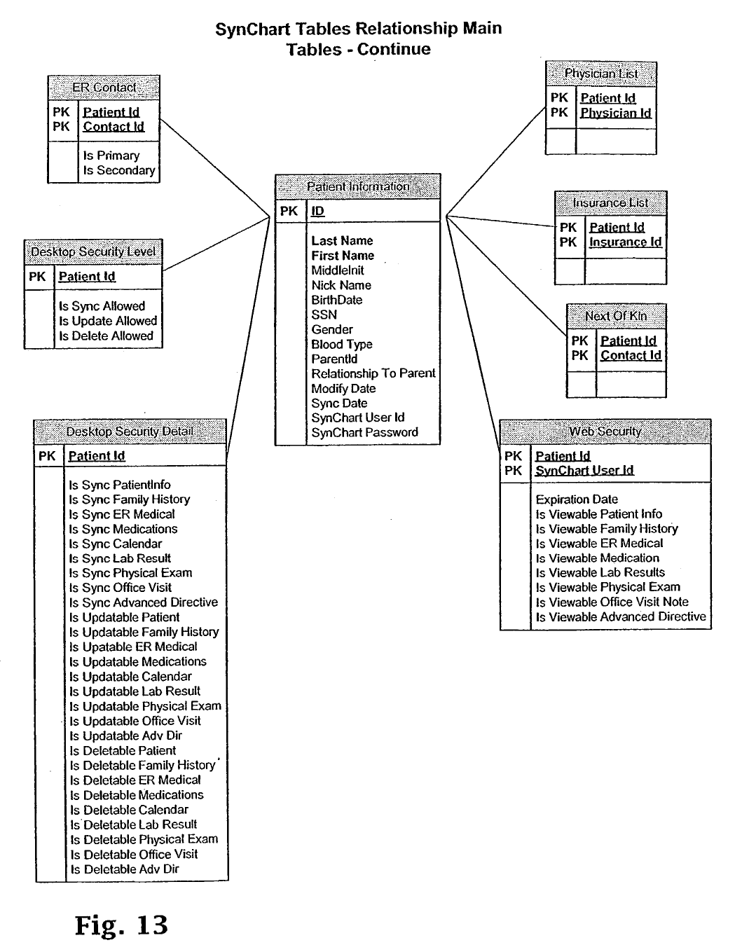

As best shown in FIG. 12 and 13, once entered the data has a relationship structure that allows the information from various files and modules to flow within the system for ease-of-user access.

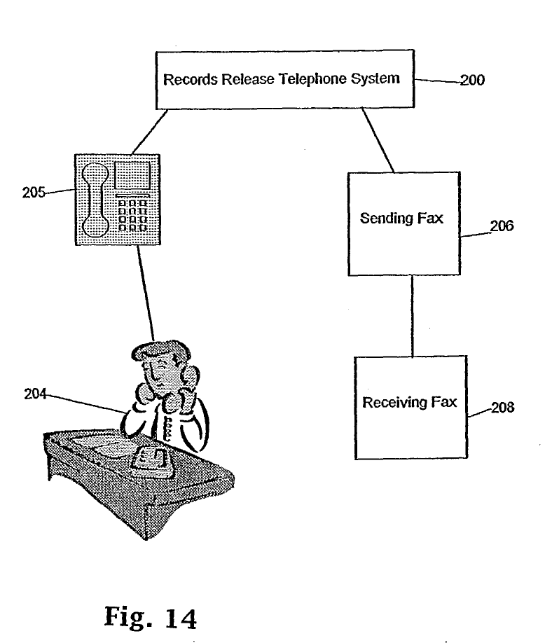

In one embodiment, and shown in FIG. 14, Internet access is not required in order to get the electronic medical records released. Rather, a records released telephone system 200 provides for a telephone 205 which includes a telephone number which may be called in an emergency. On the other side of the telephone 205, is an system operator 204. Once the operator has verified the caller's access information, the operator 204 will send out a facsimile of the medical records from a facsimile machine 206 at the operator's location to the caller's receiving facsimile machine 208. The caller's fax information is preferably preprogrammed into the system for added security.

In Use and Operation

As mentioned previously, there are basically two ways for a user to use the system 5 described above. The first is to self manage one's medical information through the use of the desktop application loaded on a personal computer, terminal or similar device.

The second method is to use a personal computer or terminal to access via a global network, like the Internet, a website portal or module which is connected to the system server. The server or servers may contain security measures to ensure the user has proper access. A patient's individual medical records are stored on the system 5 and can be accessed once the security checks have been made and verified.

The desktop application contains three main features, medical records, reports, and synchronization functionality. Additional features may include: 1) setup for the creation, removal, and archiving of up to eight or more individual patients, 2) backup and restore functions which allow the backing up of the various data sets and fields, 3) an archive function to remove a patient's medical record to another storage media, 4) an Internet connection setup program, 5) a reminder function to remind the user of backup synchronization periods, and 6) a disclaimer which must be reviewed upon opening and exiting the application.

The web application has the above functionality and also preferably the following functionality: an e-commerce portal, a list of product features, health information in the form of articles are newsletters, and member pages to view individual patient medical information and medical records online.

The web application also contains a synchronization portion or module 190 which allows the member to access the most recent medical record data forwarded to the system 5 by the member's physician or health-care provider. Upon review, the member may reject or accept the information. Once the information is accepted, the system 5 does its own data accuracy verification through a processor 26 to ensure that test results, medication names, and other information meets expected norms. If the data is inaccurate, the system 5 will notify the user, and the user may seek to verify the information with the health-care provider. Access to the information it is limited to those who use a user ID and/ or password. Whenever the member's medical record is viewed and updated, the system 5 includes that date in the date of last synchronization. No one, not even a member, can access medical data over the telephone except through a fax copy of the data.

Lab tests and results, xrays, MRIs, EKGs, etc., once received from the health-care provider may be scanned through the use of the scan module 100 which is built into the system 5. These documents may be saved in a .pdf or .tiff format for access and review at a later date.

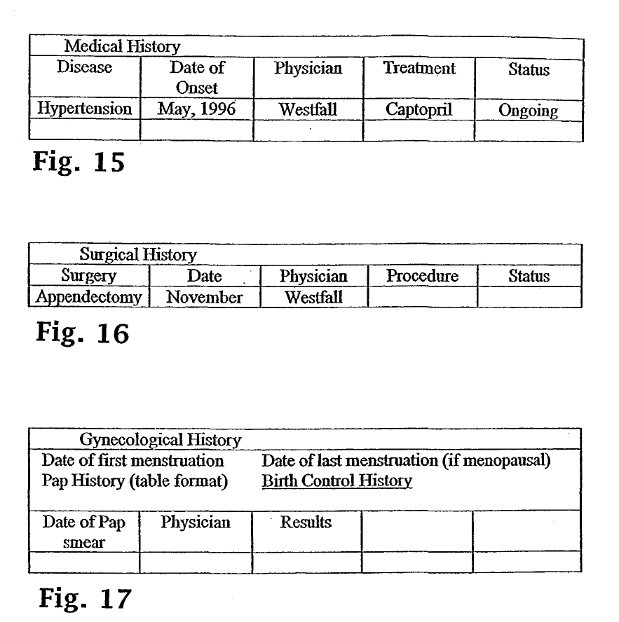

During setup of the desktop application or the web application, the system 5 will query the user for a variety of data. As is shown in FIGS. 15 through 31, the user may enter information about medical history, surgical history, pregnancy history, medical date conditioned history, medication history, immunization history, allergy history, and other test results, including CDC results, electrolyte, liver function, cardiac enzyme, cholesterol panel, coagulation panel, and urinalysis test results. The data fields which must be populated in such tables include: disease description, dates, physician name, treatment description, status, hospital name, phone number, medication names, etc..

The web application contains a homepage that includes content regarding: third patty user information and sign-in, marketing information, general medical information such as a question-and-answer section, and a trivia section, and data lookup search table. Once the member has been properly signed up, the member gains access to the member portion through member pages. When access is properly verified, a warning disclaimer will appear on the user's computer screen indicating that the information is personal and confidential and must be only accessed by a person having the proper authority. Next, a personalized homepage with customized telephone medical information based on the specific member may appear. The member can develop such a personalized homepage at his or her leisure.

There can also be access to a page to view all data synchronized or needed synchronization. This includes any personal medical information and any reminders about immunizations, appointments, or medications. Once the synchronization section has been selected, the data entered by the member is presented for review. In one preferred embodiment, the synchronization module 190 contains electronic mail information 194 which is medical record information in need of synchronization. After the member properly reviews such information and it has been accepted, it is downloaded to the system 5 and the medical records on the database are synchronized with the most current medical information.

The user initiates the synchronization by selecting from a feature on the web page or the desktop application. Synchronization is not an automatic feature that happens without the user's knowledge. Rather, the feature is fully controlled by the user. The system may send over a period of time reminders to the user to synchronize data which has been sent to the system. To synchronize, the user must answer enter the password and the user ID. Medical data that may be synchronized and uploaded to the database includes: identification information, medication history, allergy history, immunization history, medical history, surgical history, physical exam notes, office visit notes, image files etc..

The medical information is sent to the system server IO by a physician or other health-care provider. It may be possible that other treating physicians can also send information to the Web server although in the preferred embodiment access to this function is limited to the primary care physician of the user member. Nevertheless, one can imagine that it may also be advantageous to allow a school nurse, a day-care nurse, or in a senior care provider to access and uploaded medical information to the system server 10. Once the medical record data has been uploaded, it is removed from the server 10 and loaded into the system database 34 for future reference and access. In order to compress such potentially large files, they are preferably zipped or otherwise compressed.

As important federal legislation, such as the Health Information Portability and Accountability Act (HIPAA) must be complied with, the security module 50 for both applications contains numerous such mechanisms to ensure that all medical information is properly controlled and access is denied if the security measures are not met and correctly responded to. Nevertheless, if the password has been forgotten, it will be possible for the user to call a service desk to gain access to the system. An additional feature may include: upon exiting either the web application or the desktop application modules, a series of security questions will be asked to ensure that proper access has been given to the user. Preferably, there will again be a user ID number and/or a user password verification.

The web application also has a web e-commerce portal 68 which allows a guest user to order products from the website. Once the guest user indicates he or she would like to order products, they are taken to a page which requires them to provide: bill to, ship to, credit card, and password and security information. The data in these fields on these pages must be completed and verified in order for the guest user to become a member and receive products.

Additional pages which may be access contained general medical information in the form of news articles are pages, count mailing lists in contact information for special health interests, a facts about the company page, a contact us page, the security statement page, privacy statement page, legal statement page, etc..

The system 5 also may contain a variety of back office functions such as: the ability to track site usage, print reports, track access to medical records, and provide support for website users.

A medication module 70 may include additional functionality such as the provision of the medical dictionary or encyclopedia, providers notes section, an e-mail notification section to members that their medical record has been accessed, an educational system on how to better use of product and improve health, a chat room section for physician's, members, and others which can be archived for lookup at later time, and a drug information database, etc. The drug information database may include instructions on taking medications, medication dose info, side effect information, generic drug names, personal medication history info, and drug reaction information.

A growth and development module 90 allows the user to chart their own growth and development history or the growth and development of a family member. Such growth and development information includes size, weight, birth date, date of first tooth, date started walking, date started talking, etc. The module allows the user to also chart this information. It also allows the user to compare this information to population norms and to family member norms. In one such embodiment, a graphical display 38 of such info may be a tree, yardstick, or some other shape to allow for marks at certain levels.

The medical diary module 120 allows the user to make medical notes on a daily basis if desired. The user can enter into the system information on symptoms related to illness is, medication, etc..

The lab data module 130, office visit data module 140, and hospital data module 150 control the functions related to each of these modules. For example of modules control how the data is displayed, shared, accessed, manipulated, etc..

Calendar module 160 helps the user plan a monthly and yearly schedule for appointment purposes and other important medical milestones.

A charting module 170 allows for a variety of graphical displays 38 which can be shown on a computer screen. The charting module 170 thus allows for a graphic, a chart, a table, a bar chart, etc.. This module helps the user compile the various medical information and display it for ease of reference and understanding.

Although the best mode contemplated by the inventors of carrying out the present invention is disclosed herein, practice of the present invention is not limited thereto. It will be manifest that various additions, modifications and rearrangements of the features of the present invention may be made without deviating from the spirit and scope of the underlying inventive concept.

For example, the portable storage device could be enhanced by providing direct global communications network access and/or a hardwired link to the PC. Similarly, the portable storage device could include a smart card or the like. In addition, the individual components need not be fabricated from the disclosed materials, but could be fabricated from virtually any suitable materials. Moreover, the individual components need not be formed in the disclosed shapes, or assembled in the disclosed configuration, but could be provided in virtually any shape, and assembled in virtually any configuration. Further, although the modem described herein is a physically separate module, it will be manifest that the may be integrated into the apparatus with which it is associated. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended subclaims.

1. A system for storing medical records comprising:
a) a global communications network;
b) a personal computer (PC) linked to the global communications network; said PC including a first connection port;
c) a portable data access device communicably connectable to the first connection port; and
d) an electronic patient medical record carried by the portable data access device and updateable via at least one of: the global communications network and the personal computer.

2. The system of claim 1, wherein the patient medical record includes medication information and the portable access device further includes a processor and a memory.

3. The system of claim 1, wherein the portable data access device generates reminders instructing to perform a certain task.

4. The system of claim 1, wherein the portable access device includes an input device to help a patient log when a medication dose has been taken and second communication port for linking with the first communication port.

5. The system of claim 2, wherein the medication information includes dosage information and instructions on how medication should be taken.

6. The system of claim 5, wherein the instructions include at least one of the following: “taken with meals”, “taken between meals”, “taken with milk”, “taken before sleeping”, “do not operate heavy machinery”, “may make drowsy”, and “may cause dizziness”.

7. A medical data access device comprising:
a) a processor,
b) a memory linked with the processor,
c) a communications portal for communication with a global network;
d) an input device to allow data input of medical information into the memory;
e) a server computer having a data storage memory; and
f) a patient record stored in at least one memory.

8. The portable data access device of claim 7, wherein the medication information includes proper drug dosage and instructions for drug use.

9. The portable data access device of claim 7, wherein the processor generates reminders instructing a patient to take a specific dose of medication.

10. The portable data access device of claim 7, wherein the input device is used to log when a dose of medication has been taken.

11. The device of claim 7, further comprising a patient subscriber card wherein such card is scanned for patient information including system access information.

12. The device of claim 11, wherein the patient card contains a readable media such as a magnetic strip.

13. An electronic medical record system comprising:
a computer;
a medical diary module interfacing with the computer to allow a person to input a description by date;
lab, office visit, and hospitalization data modules interlinked by icons to the diary module;
a calendar module to allow a person to receive reminders upon opening the system or upon synchronization; and
a growth and development module which includes a graphic representation of persons growth and development over time.

14. The system of claim 13, further comprising a graphical user interface including a smart prompt to aid the user in populating data fields within the data modules.

15. The system of claim 15, further comprising a screen within a screen graphical user interface to access a website and give the user access to a medical dictionary.

16. The system of claim 13, further comprising a read only memory device to prevent unauthorized changes to the medical data.

17. The system of claim 13, further comprising one encryption key for accessing the system.

18. The system of claim 13, further comprising an access portal dedicated to schools.

19. The system of claim 13, further comprising an access portal dedicated to senior care facilities.

20. The system of claim 13, further comprising an access portal dedicated to physicians so that they can access the data and input data.

21. The system of claim 13, further comprising a records release system to authorize access by telephone if prior consent is given.

22. The system of claim 13, further comprising a growth and development module.

23. The system of claim 13, further comprising a photo module to scan, digitize, and store a photo of a patient.

24. The system of claim 13, further comprising a website server connected to a computer having access capability.

25. A process of maintaining medical records electronically comprising the steps of:
visiting a health care provider;
entering data on the visit at the provider's office;
sending the data via electronic mail to a patient;
reviewing the electronic mail data upon receipt;
checking the data via a processor to ensure accuracy;
identifying and correcting diagnosis or prescription errors;
accepting the data into a memory by a key holder;
creating a record from the data;
saving the record to a database; and
indicating provider input data in a different color within the record.

26. The system of claim 13, further including a drug interaction module for helping a patient coordinate and comprehend drug usage and dosage.

27. The system of claim 13, further comprising a predetermined member view only access list.

28. The system of claim 27, wherein the predetermined member includes at least one of: a personal physician; practice group of doctors by individual physician name or by group name; emergency room personal; and a family member.

29. The system of claim 28, wherein the system is a desktop software application.

30. A medical record access means which can receive and store electronic medical data comprising a computer, a means to allow the computer to communicate with a global information network by wireless communications, a means to receive and store medical records electronically, a means for transmitting the records over the network, a processor to verify accuracy of medical data for the record, an acceptance means to review the data and then transfer it to the computer if desired, a graphical display for displaying the data entered by a health care provider in a first format and data entered by anyone else in a second format, and a security means for limiting access of the record and the data.

31. The means of claim 30 wherein the medical data further comprises at least one of the following:
disease information look-up tables,
medication information look-up tables,
drug interaction information look-up tables,
health-related information look-up tables, and
recent medical advancement information look-up tables.

32. The means of claim 30, further comprising an e-commerce portal including a direct sales module, product descriptions, demonstration records, sample product distribution information.

33. The system of claim 13, further comprising a security module wherein a CD-ROM must be loaded on the computer before the system allows a user access.

34. The system of claim 33 wherein the graphic includes at least one of the following: a doorway or a tree either of which allows the user to visually make marks representing growth for children having a link from each mark to a screen with: photo, height, weight, and significant milestone information, and further comprising e-mail capability to enable the user to send the information.

35. The system of claim 33 further comprising a charting module so that the user can chart an individual against siblings and parents, and can chart against norms to detect poor diet, need for exercise, obesity or bone deterioration.

36. The system of claim 33 wherein such reminders include at least one of the following:
refill blood pressure prescription in one week; and schedule provider appointment.

37. A system for automated medical records data storage comprising:
a desktop computer program application having as many as eight individual medical data files, password protection, and an auto-intelligence module to provide for ease of data input by referencing to current data files of diseases and medication;
a website module which interfaces with the program to synchronize the data with a centralized medical record data file;
a graphical user interface which can synchronize at least one of the following types of data medications, allergies, and hospitalizations; and
a key holder security module to allow access to the data and the ability edit it.

38. The system of claim 37 further comprising an input module to identify differences between patient entered data and physician /physician office entered data; and a login module to limit access to data to at least one of the following: a patient's primary care physician, a physician's office members, emergency room (ER) members, an operator driven phone release mechanism triggered by calling a predetermined phone number so that an operator will release record, a predetermined ER fax to gain a fax release of record, and holder of a patient identification card.

39. The system of claim 38 further comprising a synchronization module which includes:
a. user control of what is synchronized and when,
b. deleted data verification, and
c. service termination confirmation with six months to retrieve archived data.

40. The system of claim 39 further comprising product protection module winch includes:
a. a mechanism to prevent copy of a CD-ROM,
b. a CD tray which must hold the CD-ROM in order for it to run.

41. The system of claim 39 further comprising a demonstrational CD which is fully functional except that it does not synchronize and has a 30 day trial life with warnings of days remaining.

42. The system of claim 39 further comprising a security module to protect blood type information, disease information, and advanced directives, the security module having the ability to mark an entire record by date of last review.

43. The system of claim 41 further comprising a patient identification card with patient selected data which includes at least one of the following:
i. blood type,
ii. medication/food allergies,
iii. medication/food sensitivities,
iv. photograph, and
v. printed I.D. number.
